(19) United States
(12) Patent Application Publication
(10) Pub. No.: US 2026/0192747 A1
(43) Pub. Date: Jul. 9, 2026

(54) INTELLIGENT VEHICLE EARLY WARNING TRIPOD SYSTEM AND A CONTROL METHOD THEREOF

(71) Applicant: CHONGQING NUMENX INTELLIGENT EQUIPMENT CO., LTD., Chongqing (CN)

(72) Inventor: Jianfeng Zhang, Chongqing (CN)

(21) Appl. No.: 19/358,806

(22) Filed: Oct. 15, 2025

(30) Foreign Application Priority Data
Jan. 6, 2025 (CN) 202510012600.8

(51) Int. Cl. B60Q 7/00; G05D 1/617; G05D 105/55; G05D 109/10; G05D 111/10; G07C 5/00; G07C 5/08; G09F 13/04; G09F 13/16

(52) U.S. Cl. CPC B60Q 7/00; G05D 1/617; G07C 5/008; G07C 5/0808; G09F 13/0463; G09F 13/16; G05D 2105/55; G05D 2109/10; G05D 2111/10

(57) ABSTRACT

An intelligent vehicle early warning tripod system includes moving wheel bodies, a vehicle body, a cover plate, a travel motor, a telescopic frame, auxiliary wheels, and a tripod assembly; the cover plate is fixed on a top of the vehicle body; the travel motor is fixed on a bottom of vehicle body; the moving wheel body is connected to an output end of the travel motor; the telescopic frame is slidably arranged on a side of the vehicle body; the auxiliary wheels are rotatably arranged on the telescopic frame; and the tripod assembly is arranged on the vehicle body or the telescopic frame. Sending a fault signal when a vehicle malfunctions; after receiving the fault signal, the intelligent vehicle early warning tripod system lowers itself to the ground; the intelligent vehicle early warning tripod system moves to the designated position, and deploys the tripod to issue warnings during movement.

### TECHNICAL FIELD

The invention relates to the technical field of warning devices, in particular to an intelligent vehicle early warning tripod system and a control method thereof.

### BACKGROUND ART

A vehicle warning tripod, also known as a triangular warning sign, a broken-down vehicle warning sign, or an emergency parking sign, is a device used to alert other road users when a vehicle breaks down or is involved in an accident. It is usually an equilateral triangle with a red border, and there is a white “!” or other warning symbols inside. Its high-visibility color and design ensure that it can be clearly seen both during the day and at night.

The prior art provides an electrically remote-controlled tripod, which includes a base and a tripod body. A bottom of the base is provided with driving wheels, and one side of the base is provided with a tripod body. The tripod body is composed of a protective layer, an impact-resistant layer, a waterproof layer, a lamp tube placement layer, and a reinforcement layer. An interior of the base is provided with a power module, a control module, and an LED control module. In the invention, the tripod body is composed of the protective layer, the impact-resistant layer, the waterproof layer, the lamp tube placement layer, and the reinforcement layer, which endows it with good toughness, resistance to breakage, strong repairability, high light transmittance, good shock absorption, energy absorption and buffering effects, low density, durability, and environmental friendliness. The signal receiving module transmits control signals to the control module, the control module controls each module, and the independent motor drive module controls the driving wheels, which facilitates the movement of the tripod. When the vehicle cannot move on an expressway, remote control can be used to avoid dangers, and personnel can control the movement of the tripod from a safe position.

However, the tripod adopting the above structure has a narrow structure at bottom for supporting the tripod. Under the conditions of strong wind and rapid jolting during movement, it is not conducive to maintaining the structural stability of the tripod during movement, thus making it inconvenient to use.

### SUMMARY OF THE INVENTION

The purpose of the invention is to provide an intelligent vehicle early warning tripod system and a control method thereof, aiming to provide more stable support so that the tripod can remain stable without toppling over during movement, thereby making it more convenient to use.

To achieve the above purpose, in the first aspect, the invention provides an intelligent vehicle early warning tripod system, which includes moving wheel bodies, a vehicle body, a cover plate, a travel motor, a telescopic frame, auxiliary wheels, and a tripod assembly; the cover plate is fixed on a top of the vehicle body; the travel motor is fixed on a bottom of vehicle body; the moving wheel body is connected to an output end of the travel motor; the telescopic frame is slidably arranged on a side of the vehicle body; the auxiliary wheels are rotatably arranged on the telescopic frame; and the tripod assembly is arranged on the vehicle body or the telescopic frame.

Wherein, the telescopic frame includes slide rails, slide blocks, and a drive structure; the slide rails are fixed to the side of the vehicle body; the slide blocks are slidably arranged inside the slide rails; and the drive structure is used to drive the slide block to move.

Wherein, the drive structure includes a rack, a first gear, a transmission shaft, a second gear a third gear, and a second motor; the rack is fixed to the slide block; the transmission shaft is rotatably arranged inside the vehicle body; the first gear is fixedly connected to the transmission shaft and meshes with the rack; the second gear is fixed to the transmission shaft; and the second motor drives the second gear to rotate through the third gear.

Wherein, the drive structure further includes a photoelectric detection unit, which is used to detect the movement information of the slide blocks.

Wherein, the telescopic frame further includes an anti-collision cover, which is fixed on the slide blocks.

Wherein, the telescopic frame further includes a counterweight block, which is arranged on the slide blocks.

Wherein, the tripod includes a mounting structure, a first tilt motor, a first tilt rod, a second tilt motor, and a second tilt rod; the mounting structure is used for installation on the vehicle body or the telescopic frame; the first tilt motor is fixed to the mounting structure and is used to drive the first tilt rod to rotate; the second tilt motor is fixed to the mounting structure and is used to drive the second tilt rod to rotate; and the first tilt rod and the second tilt rod form an inverted triangular structure.

Wherein, warning lights are arranged on the first tilt rod and the second tilt rod.

In the second aspect, the invention also provides a control method for an intelligent vehicle early warning tripod system, including sending a fault signal when a vehicle malfunctions or the intelligent vehicle early warning tripod system detects an abnormality;
after receiving the fault signal, the intelligent vehicle early warning tripod system lowers itself to the ground;
the intelligent vehicle early warning tripod system moves to the designated position, and deploys the tripod to issue warnings during movement.

Wherein, after receiving the fault signal, the intelligent vehicle early warning tripod system is further used to transmit the fault signal to an upper computer;
the upper computer parses the fault signal and identifies the type of vehicle fault;
issue the type of vehicle fault to mobile terminals within a preset range around the fixed location to issue warnings.

In an intelligent vehicle early warning tripod system and its control method of the invention, the moving wheel bodies serve as a power output component of the entire early warning tripod system, and are directly connected to output end of the travel motor. The vehicle body is the main frame of the early warning tripod system; it not only bears all internal components but also provides necessary protection. The vehicle body is usually made of high-strength yet lightweight materials, such as aluminum alloy or composite plastic, which not only ensures structural strength but also facilitates handling and transportation. The cover plate is fixed on the top of the vehicle body, and its main function is to protect internal electronic equipment from the impact of the external environment, such as rainwater, dust, and the like. The travel motor is installed inside the vehicle body and is responsible for driving the moving wheel body. It can automatically adjust the speed and direction according to preset programs or remote instructions, realizing autonomous movement under unmanned operation. The telescopic frame is slidably arranged on the side of the vehicle body and is used to adjust the position of the auxiliary wheels. This enables four-point support during movement, thereby enhancing the stability of movement. The tripod may be equipped with LED warning lights, reflective strips, and a programmable display screen to convey information to surrounding road users.

To sum up, the above-mentioned structure can provide better and more stable support, ensuring that the tripod remains stable without toppling over during movement, thus making it more convenient to use.

### BRIEF DESCRIPTION OF ACCOMPANY DRAWINGS

In order to illustrate the preferred embodiment of the invention or the technical scheme more clearly, the technical scheme of the preferred embodiment or the figures required by the prior art is further described briefly. Obviously, only partial embodiments of the invention are shown and the actual structure is not limited thereto. It is to be understood by those skilled in the art that other drawings can be obtained based on the drawings of the invention with non-creative labor.

FIG. 1 is a structural diagram of an intelligent vehicle early warning tripod system of the invention.

FIG. 2 is a right-side structural diagram of an intelligent vehicle early warning tripod system of the invention.

FIG. 3 is a left-side structural diagram of an intelligent vehicle early warning tripod system of the invention.

FIG. 4 is an internal structural diagram of an intelligent vehicle early warning tripod system of the invention.

FIG. 5 is a cross-sectional view of an intelligent vehicle early warning tripod system of the invention.

FIG. 6 is a partial enlarged view of Detail A in FIG. 5.

FIG. 7 is a first flow chart of a control method for an intelligent vehicle early warning tripod system of the invention.

FIG. 8 is a second flow chart of a control method for an intelligent vehicle early warning tripod system of the invention.

In the drawings: 101 moving wheel body, 102 vehicle body, 103 cover plate, 104 travel motor, 105 telescopic frame, 106 auxiliary wheel, 107 tripod assembly, 108 slide rail, 109 slide block, 111 rack, 112 first gear, 113 transmission shaft, 114 second gear, 115 third gear, 116 second motor, 117 photoelectric detection unit, 118 anti-collision cover, 119 counterweight block, 120 mounting structure, 121 first tilt motor, 122 first tilt rod, 123 second tilt motor, 124 second tilt rod.

### SPECIFIC EMBODIMENT OF THE INVENTION

The embodiments of the invention are described in detail below. Examples of the embodiments are shown in the accompanying drawings, where the same or similar reference numerals denote the same or similar elements or elements with the same or similar functions throughout. The embodiments described below with reference to the accompanying drawings are exemplary and are intended to explain the invention, but should not be construed as limiting the invention.

In the description of the invention, it should be understood that terms such as “length”, “width”, “upper”, “lower”, “front”, “rear”, “left”, “right”, “vertical”, “horizontal”, “top”, “bottom”, “inner”, and “outer” indicate orientations or positional relationships based on the orientations or positional relationships shown in the accompanying drawings. These terms are only for the convenience of describing the invention and simplifying the description, and do not indicate or imply that the device or element referred to must have a specific orientation, be constructed and operated in a specific orientation. Therefore, they should not be construed as limiting the invention. In addition, in the description of the invention, the meaning of “plurality” is two or more, unless otherwise clearly and specifically defined.

### Embodiment 1

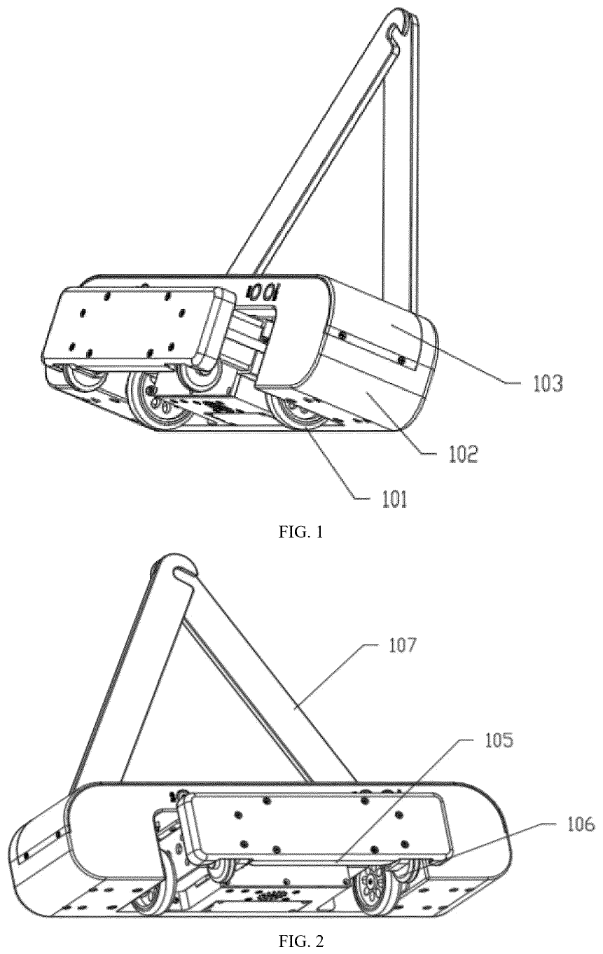

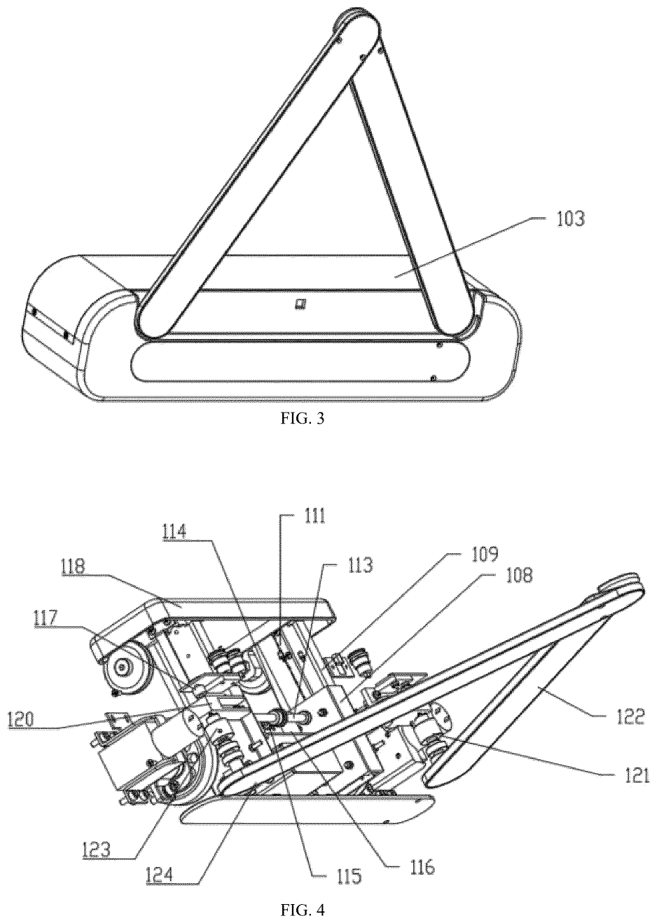

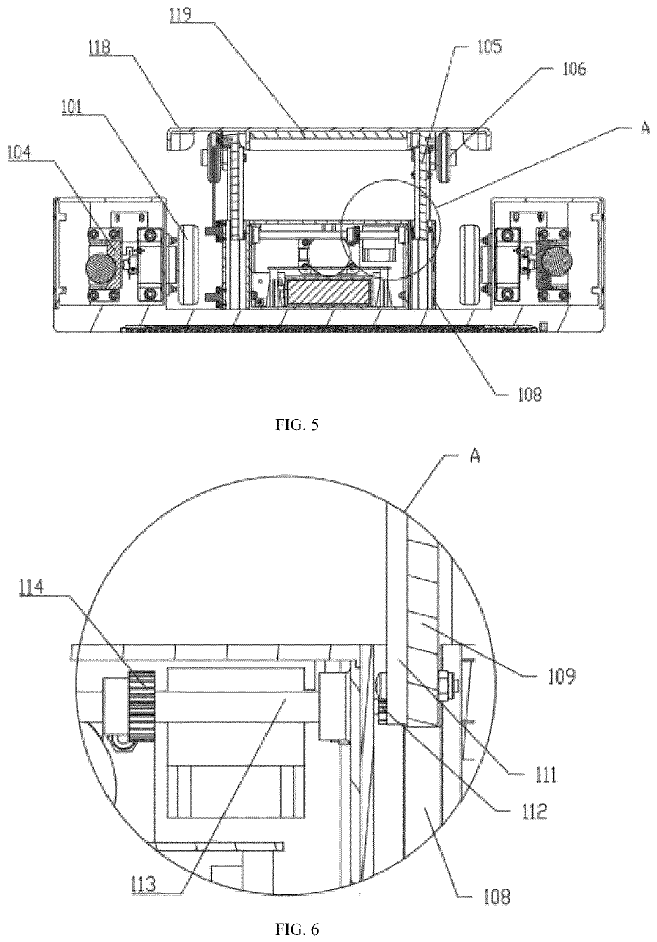

Please refer to FIG. 1 to FIG. 6, the invention provides an intelligent vehicle early warning tripod system, which includes moving wheel bodies 101, a vehicle body 102, a cover plate 103, a travel motor 104, a telescopic frame 105, auxiliary wheels 106, and a tripod assembly 107; the cover plate 103 is fixed on a top of the vehicle body 102; the travel motor 104 is fixed on a bottom of the vehicle body 102; the moving wheel body 101 is connected to an output end of the travel motor 104; the telescopic frame 105 is slidably arranged on a side of the vehicle body 102; the auxiliary wheels 106 are rotatably arranged on the telescopic frame 105; and the tripod assembly 107 is arranged on the vehicle body 102 or the telescopic frame 105.

In this embodiment, the moving wheel bodies 101 are power output parts of the entire early warning tripod system, and it is directly connected to an output end of the travel motor 104; the vehicle body 102 is a main frame of the early warning tripod system. It not only bears all internal components but also provides necessary protection. The vehicle body 102 is usually made of high-strength yet lightweight materials, such as aluminum alloy or composite plastic, which ensures structural strength while facilitating handling and transportation.

The cover plate 103 is fixed on the top of the vehicle body 102, and its main function is to protect internal electronic equipment from external environmental factors such as rainwater and dust. The travel motor 104 is installed inside the vehicle body 102 and is responsible for driving the moving wheel bodies 101. It can automatically adjust the speed and direction according to preset programs or remote commands to realize autonomous movement under unmanned operation.

The telescopic frame 105 is slidably arranged on the side of the vehicle body 102 and is used to adjust the position of the auxiliary wheels 106, which provides four-point support during movement, thereby enhancing the stability of movement.

The tripod may be equipped with LED warning lights, reflective strips, and a programmable display screen to convey information to surrounding road users.

To sum up, the above structure can provide better and more stable support, ensuring that the tripod remains stable without toppling during movement, thus making it more convenient to use.

The telescopic frame 105 includes slide rails 108, slide blocks 109, and a drive structure; the slide rails 108 are fixed to the side of the vehicle body 102; the slide blocks 109 are slidably arranged inside the slide rails 108; and the drive structure is used to drive the slide block 109 to move.

The slide rails 108 are fixed on the side of the vehicle body 102 and provide a stable guiding path for the slide blocks 109. The material of the slide rails 108 should be selected with consideration for wear resistance and strength to ensure stable performance during long-term use. The slide blocks 109 can be driven to move by the drive structure, and it is embedded with balls or similar low-friction elements inside, allowing it to slide smoothly in the slide rails 108 while reducing mechanical wear.

The drive structure includes a rack 111, a first gear 112, a transmission shaft 113, a second gear 114, a third gear 115, and a second motor 116; the rack 111 is fixed to the slide block 109; the transmission shaft 113 is rotatably arranged inside the vehicle body 102; the first gear 112 is fixedly connected to the transmission shaft 113 and meshes with the rack 111; the second gear 114 is fixed to the transmission shaft 113; and the second motor 116 drives the second gear 114 to rotate through the third gear 115.

The rack 111 is fixed on the slide block 109 and meshes with the first gear 112, transmitting power to the slide block 109 through linear motion.

The first gear 112 of a gear set is fixedly connected to the transmission shaft 113 and directly meshes with the rack 111, responsible for converting rotational motion into linear motion. The second gear 114 is also fixed on the transmission shaft 113 and is used to increase the transmission ratio and optimize power transmission efficiency. The third gear 115 is driven by the second motor 116 and works in cooperation with the second gear 114 to provide sufficient torque to drive the entire drive system.

The transmission shaft 113 is located inside the vehicle body 102 and is rotatably arranged, serving as a bridge for power transmission to connect the various gears.

The drive structure further includes a photoelectric detection unit 117, which is used to detect the movement information of the slide blocks 109.

To accurately monitor the position and movement status of the slide block 109, the photoelectric detection unit 117 is integrated into the drive structure. This component can real-time detect the displacement information of the slide block 109 relative to the slide rail 108 and feed the data back to the control system. The photoelectric detection unit 117 usually consists of an emitter and a receiver. When the light beam is blocked, the receiver sends a signal to the controller, indicating the specific position of the slide block 109, which not only helps to improve the automation level of the system but also prevents damage caused by misoperation.

The telescopic frame 105 further includes an anti-collision cover 118, which is fixed on the slide blocks 109.

Considering safety in practical applications, the telescopic frame 105 is equipped with the anti-collision cover 118. This device is fixed on the slide blocks 109 and plays a buffering role in the event of an accidental collision, protecting internal mechanical components from damage. The anti-collision cover 118 can be made of elastic materials such as rubber or plastic, which can effectively absorb impact energy without causing secondary damage to other vehicles.

The telescopic frame 105 further includes a counterweight block 119, which is arranged on the slide blocks 109.

To maintain the balance of the telescopic frame 105 in different extended states, especially when the auxiliary wheels 106 are extended and in contact with the ground, the counterweight block 119 is arranged on the slide block 109. The weight distribution of the counterweight block 119 can be adjusted as needed to ensure that the tripod stands stably at any angle. In addition, a reasonable counterweight design can also help reduce the workload of the travel motor 104 and improve overall operation efficiency.

The tripod includes a mounting structure 120, a first tilt motor 121, a first tilt rod 122, a second tilt motor 123, and a second tilt rod 124; the mounting structure 120 is used for installation on the vehicle body 102 or the telescopic frame 105; the first tilt motor 121 is fixed to the mounting structure 120 and is used to drive the first tilt rod 122 to rotate; the second tilt motor 123 is fixed to the mounting structure 120 and is used to drive the second tilt rod 124 to rotate; and the first tilt rod 122 and the second tilt rod 124 form an inverted triangular structure.

The first tilt motor 121 is fixed to the mounting structure 120 and drives the first tilt rod 122 to rotate through gears or other transmission mechanisms. The motor should have sufficient torque output to ensure stable operation under various load conditions. At the same time, it should support precise angle control to ensure that the preset position is reached during each deployment. The first tilt rod 122 is connected to the first tilt motor 121 and completes the rotation after receiving power.

The second tilt motor 123 is also fixed to the mounting structure 120 but is used to drive the second tilt rod 124. The two motors can work synchronously or operate independently, depending on the requirements of the application scenario. Similar to the first tilt rod 122, the second tilt rod 124 also serves as part of the support and jointly forms a stable inverted triangular shape with the first tilt rod 122 to form a triangular warning structure.

Warning lights are arranged on the first tilt rod 122 and the second tilt rod 124.

To enhance the safety warning function of the tripod, warning lights are arranged on the first tilt rod 122 and the second tilt rod 124. These warning lights are not only visual warning tools but also important means to ensure traffic safety at night or in low-visibility environments.

### Embodiment 2

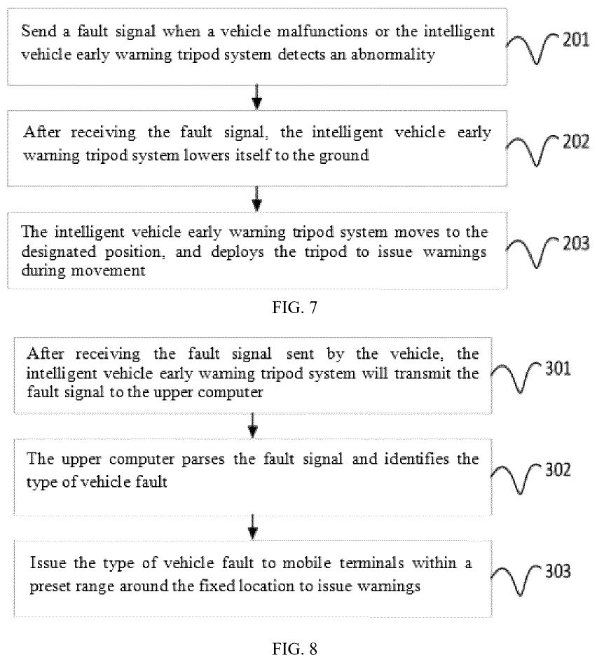

Please refer to FIG. 7 to FIG. 8. The invention also provides a control method for an intelligent vehicle early warning tripod system, including the following steps:
S201: send a fault signal when a vehicle malfunctions or the intelligent vehicle early warning tripod system detects an abnormality;

When any part of the vehicle malfunctions or the early warning system itself detects an abnormal situation, the system will immediately start the emergency response procedure. Specifically:

The vehicle is equipped with various types of sensors, such as pressure sensors, temperature sensors, and vibration sensors, to monitor the vehicle status in real time. These sensors can promptly detect abnormal conditions such as tire leaks, engine overheating, and vehicle body tilt.

Once the sensor data exceeds the normal range, the fault diagnosis module will conduct a rapid analysis and confirm whether there is an actual problem. If a problem is indeed present, a fault signal will be generated.

The fault signal is transmitted to the early warning system through an in-vehicle CAN bus or other dedicated communication protocols. In addition, the vehicle can also send alarm information to a remote service center via a wireless network to obtain further technical support.
S202: after receiving the fault signal, the intelligent vehicle early warning tripod system lowers itself to the ground;
after receiving the fault signal, the early warning system will perform a series of preset actions to prepare for deployment and movement to the appropriate position:
the system first ensures that it is in a working state, including checking the battery level and activating internal electronic equipment. A comprehensive self-inspection is conducted to verify the normal operation of all components, such as the functionality of mechanical parts (e.g., motors, gears, and slide rail 108) and the accuracy of sensors and controllers. If the self-inspection result is good, the early warning system will automatically separate from the vehicle body 102 and slowly lower to the ground.
S203: the intelligent vehicle early warning tripod system moves to the designated position, and deploys the tripod to issue warnings during movement.
after completing the initial deployment, the early warning system will autonomously move to the designated safe position according to a pre-programmed path or a dynamic planning algorithm based on environmental perception, and during this process, complete the deployment of the tripod and the activation of the warning device:
use built-in positioning and navigation tools such as GPS, lidar, or cameras to determine the optimal travel route. The system can identify surrounding obstacles and other vehicles and select the safest travel path that does not affect traffic flow.
after reaching the target position, the drive structure on the telescopic frame 105 will drive the first tilt rod 122 and the second tilt rod 124 to extend outward, forming a stable inverted triangular support structure. At the same time, the warning lights installed on the tilt rods will be turned on, emitting strong light signals to remind passing drivers to pay attention.

Once the tripod is fully deployed, all warning devices will enter the working state, including but not limited to the flashing of LED warning lights and the sounding of audible alarms. These measures are intended to attract attention to the greatest extent possible and ensure the safety of personnel and vehicles at the accident site.

Throughout the process, the early warning system can maintain contact with the remote monitoring center through a wireless communication module, upload real-time status information, and receive operation instructions from the background, thereby achieving more efficient management and scheduling.
after receiving the fault signal, the intelligent vehicle early warning tripod system is further used to:
S301: transmit the fault signal to an upper computer;
after receiving the fault signal sent by the vehicle, the intelligent vehicle early warning tripod system will immediately transmit this data to the upper computer (central control system or remote server) through a secure and reliable communication channel. This process includes the following aspects:
to ensure the security and integrity of the data, the fault signal will be encrypted before transmission to prevent information leakage or tampering. Wireless communication technologies such as 4G/5G, Wi-Fi, and Bluetooth are used to ensure that the fault signal can be quickly and stably uploaded to the upper computer in any environment. For remote areas or locations with insufficient signal coverage, the system can also be equipped with satellite communication as a backup solution.

To improve the reliability of the system, multiple transmission paths can be set up. Once the main path fails, the backup path will automatically take over to ensure uninterrupted data transmission.
S302: the upper computer parses the fault signal and identifies the type of vehicle fault;

After receiving the fault signal, the upper computer will start a dedicated fault diagnosis program to conduct in-depth analysis of the signal and determine the specific type of fault. This step involves the following key links:

First, the received data is decrypted, and its integrity and legality are checked to ensure the credibility of the information source. Based on a preset fault mode database, the upper computer will compare parameters in the fault signal (such as sensor readings and error codes) to match the corresponding fault type. For example, engine overheating may be caused by insufficient coolant, a faulty cooling fan, etc. ; low tire pressure may indicate a leak or other problems.
S303: issue the type of vehicle fault to mobile terminals within a preset range around the fixed location to issue warnings.

After completing the analysis of the fault type, the upper computer will issue relevant information to mobile terminals within a certain range around the accident site to promptly notify nearby road users. The specific operations are as follows:

Based on the vehicle's position information, a reasonable geofence is delineated on the map, usually centered on the accident site with a radius ranging from several hundred meters to several kilometers. The selection of this range needs to consider factors such as road type and traffic flow.

By cooperating with mobile network operators or using third-party service platforms, the upper computer can identify all active mobile terminals within the geofence, such as smartphones, tablets, and the like.

For the screened target devices, the system will send detailed fault information and safety reminders in the form of push notifications. The content may include text descriptions, voice broadcasts, and even animated demonstrations to ensure that users can intuitively understand the current situation.

Some advanced versions of the system also support a two-way communication function, allowing recipients to reply with confirmation messages to indicate that they have noticed the warning. In addition, if there are professional rescue teams or service stations nearby, they can also receive notifications synchronously, facilitating rapid response.

To sum up, the fault handling and early warning mechanism of the intelligent vehicle early warning tripod system is a highly intelligent process. It integrates advanced communication technologies, data analysis capabilities, and extensive user reach methods, aiming to minimize the probability of traffic accidents and improve the efficiency of emergency response.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. An intelligent vehicle early warning tripod system, including moving wheel bodies, a vehicle body, a cover plate, and a travel motor, wherein the cover plate is fixed on a top of the vehicle body; the travel motor is fixed on a bottom of vehicle body; the moving wheel body is connected to an output end of the travel motor;
the intelligent vehicle early warning tripod system further includes a telescopic frame, auxiliary wheels, and a tripod assembly; the telescopic frame is slidably arranged on a side of the vehicle body; the auxiliary wheels are rotatably arranged on the telescopic frame; and the tripod assembly is arranged on the vehicle body or the telescopic frame.

2. The intelligent vehicle early warning tripod system according to claim 1, wherein the telescopic frame includes slide rails, slide blocks, and a drive structure; the slide rails are fixed to the side of the vehicle body; the slide blocks are slidably arranged inside the slide rails; and the drive structure is used to drive the slide block to move.

3. The intelligent vehicle early warning tripod system according to claim 2, wherein the drive structure includes a rack, a first gear, a transmission shaft, a second gear a third gear, and a second motor; the rack is fixed to the slide block; the transmission shaft is rotatably arranged inside the vehicle body; the first gear is fixedly connected to the transmission shaft and meshes with the rack; the second gear is fixed to the transmission shaft; and the second motor drives the second gear to rotate through the third gear.

4. The intelligent vehicle early warning tripod system according to claim 3, wherein the drive structure further includes a photoelectric detection unit, which is used to detect the movement information of the slide blocks.

5. The intelligent vehicle early warning tripod system according to claim 4, wherein the telescopic frame further includes an anti-collision cover, which is fixed on the slide blocks.

6. The intelligent vehicle early warning tripod system according to claim 5, wherein the telescopic frame further includes a counterweight block, which is arranged on the slide blocks.

7. The intelligent vehicle early warning tripod system according to claim 6, wherein the tripod includes a mounting structure, a first tilt motor, a first tilt rod, a second tilt motor, and a second tilt rod; the mounting structure is used for installation on the vehicle body or the telescopic frame; the first tilt motor is fixed to the mounting structure and is used to drive the first tilt rod to rotate; the second tilt motor is fixed to the mounting structure and is used to drive the second tilt rod to rotate; and the first tilt rod and the second tilt rod form an inverted triangular structure.

8. The intelligent vehicle early warning tripod system according to claim 7, wherein warning lights are arranged on the first tilt rod and the second tilt rod.

9. A control method for an intelligent vehicle early warning tripod system adopting the intelligent vehicle early warning tripod system according to claim 1, including sending a fault signal when a vehicle malfunctions or the intelligent vehicle early warning tripod system detects an abnormality;
after receiving the fault signal, the intelligent vehicle early warning tripod system lowers itself to the ground;
the intelligent vehicle early warning tripod system moves to the designated position, and deploys the tripod to issue warnings during movement.

10. The control method for an intelligent vehicle early warning tripod system according to claim 9, wherein after receiving the fault signal, the intelligent vehicle early warning tripod system is further used to transmit the fault signal to an upper computer;
the upper computer parses the fault signal and identifies the type of vehicle fault;
issue the type of vehicle fault to mobile terminals within a preset range around the fixed location to issue warnings.
